(19) United States
(12) Patent Application Publication
(10) Pub. No.: US 2010/0251717 A1
(43) Pub. Date: Oct. 7, 2010

(54) Propelling Device by Means of Matter Particles Acceleration, and Applications of this Device

(76) Inventor: Claude Poher, Toulouse (FR)

Correspondence Address: ABELMAN, FRAYNE & SCHWAB, 666 THIRD AVENUE, 10TH FLOOR, NEW YORK, NY, 10017, US

(21) Appl. No.: 12/224,028

(22) PCT Filed: Feb. 13, 2007
(86) PCT No.: PCT/FR2007/000249

§ 371 Date: Jun. 10, 2010

(30) Foreign Application Priority Data
Feb. 14, 2006 (FR) 06 01274

(51) Int. Cl. F03G 7/00

(52) U.S. Cl. 60/721

(57) ABSTRACT

Propelling device by way of matter particles acceleration, including device for accelerating the particles of matter, mainly in only one direction. The aforementioned device includes an energy source and an enclosure containing the matter particles to be accelerated, the enclosure being powered from the the energy source.

### CROSS REFERENCE TO RELATED APPLICATIONS

This application claims priority under 35 U.S.C. §371 to international application No. PCT/FR2007/000249, filed on Feb. 13, 2007, which claims priority to French application No. 0601274, filed on Feb. 14, 2006, the contents of which are incorporated by reference in their entirety.

### FIELD OF INVENTION

This invention concerns propelling devices by means of matter particles acceleration, and their applications.

This invention concerns particularly devices used to create, from a distance, and without contact, a pushing acceleration of matter. In certain conditions, these devices propel themselves. This pushing and/or this auto propelling acceleration is obtained thanks to the anisotropic spatial distribution of natural quantum elements of an experimentally demonstrated interaction, this quantum elements being called <<Universons>> by the creator. The said anisotropy being obtained artificially thanks to the invention.

The invention is extended to all applications using such devices.

### BACKGROUND OF INVENTION

### Previous Knowledge

The invention principle uses the results of the scientific study of natural gravitation, in order to try explaining several experimentally observed anomalies. The creator of this invention has effectively elaborated, since 1980, a physics theory of gravitation from the hypothesis that this interaction is caused by a quantified natural flux of quantum bearers of kinetic impulse, called “ Universons ” by the author since 1983, in a first manuscript of the theory. The Universons being the gravitation quantum elements interacting feebly with matter. The Universons, in this theory, are responsible for inertia and gravitation.

The theory was first published on Dec. 15, 1988. This publication was then upgraded in October 1991.

The Universons theory has been officially presented publicly at the 43rd Congress of the International Astronautical Federation (IAF) on Sep. 28, 1992, in Washington D.C. USA. Then it was presented at the Conference organized by the French National Defence General Secretariat in Paris, on February 1993. The following year, it was presented at the International conference organized by the American Institute for Aeronautics and Astronautics (AIAA) in New York city N.Y. about propulsion of the future interstellar space missions.

This physics theory has been then published by the invention author in a french book entitled “Gravitation, les Universons, énergie du futur”, edited by “Editions du Rocher” in October 2003 (ISBN 2 268 0489).

The theory is also electronically published since 2004, notably on the Internet sites www.universons.eu, www.universons.org, www.universons.com in English and French languages.

The Universons theory has allowed the creator to predict new facts that have effectively been observed since a long time without being explained previously. For example, the existence of a cosmological acceleration, caused by the Universe expansion, acceleration increasing the one of any accelerated material object. This cosmological acceleration is equal to Hc product of the Hubble constant H by the speed of light c.

This very feeble acceleration (with an amplitude of about 8.10⁻⁸ m/s²) modifies the trajectory of interplanetary space probes. It has been confirmed by the trajectography of several space missions, and is known from fundamental research publications by NASA.

This same cosmological acceleration Hc has also for consequence to modify strongly the gravitation, at low acceleration level, inside the large astronomical structures of the Universe, such as in the galaxies and in the clusters of galaxies. These phenomena have also effectively been observed and these observations have been published by astronomers in fundamental research publications. Therefore, the Universons theory seems to be the expression of natural reality.

The Universons theory has also allowed the invention creator to imagine several means to create an acceleration analogous to the gravitational acceleration, means able to produce several effects that have been effectively observed fortuitously, in Finland and in Russia, observations that have been published as seen, without being understood or correctly interpreted.

Therefore, the invention is a direct application of this theory which is experimentally confirmed and that has been officially presented publicly to the scientific community, with its experimental confirmations.

### SUMMARY OF INVENTION

Hence, the object of the present invention is a propulsion device, by means of acceleration of particles, including means for accelerating the particles of matter, mainly in only one direction, said means including an energy source and an enclosure containing the matter particles to be accelerated, said enclosure being powered from the said energy source.

Advantageously, said matter particles are in particular electrons, protons, neutrons and/or ions.

According to a first embodiment, said enclosure includes at least a superconductor.

Advantageously, said means further include a cooling cryostat to cool down at least one superconductor to a temperature lower than its critical temperature.

Advantageously, said enclosure includes a superconductor material made of several layers having slightly different chemical compositions and critical temperatures, in order to obtain, at the functioning temperature, one or several partly superconductive transition zones, one or several superconductive zones, and one or several conductive zones.

Advantageously, said enclosure includes first and second layers of superconductor material, separated by a transition zone, the critical temperature of the second layer being lower than the critical temperature of the first layer, the critical temperature of the transition zone being between the critical temperatures of said first and second layers of superconductor materials, such that, at the functioning temperature, the first layer is superconductive, and the second layer is not superconductive, the transition zone being partly superconductive.

According to a second embodiment, said enclosure is not conductive, it is airtight, and it contains a gas that can be easily ionized.

Advantageously, said enclosure is powered by a voltage generator, providing ion discharges, the ions being accelerated inside said enclosure by appropriate electromagnetic fields.

Advantageously, said energy source is continuous, alternative or pulsed.

The present invention has also for object the use of a device as previously described, to create, from a distance, and without contact, a pushing acceleration of any matter, said acceleration having the properties of the gravitational acceleration, and said acceleration being obtained artificially by means of matter particles acceleration, these accelerated matter particles remaining confined inside said device.

The present invention has also for object the use of a device as previously described, to create an auto propulsive acceleration of the said device itself, said acceleration being obtained artificially by means of matter particles acceleration, these accelerated matter particles remaining confined inside said device.

The present invention has also for object the use of a device as previously described, to produce electric energy at a distance by means of a propulsive flux.

### BRIEF DESCRIPTION OF THE DRAWINGS

These characteristics and advantages, and others, of the present invention will appear more clearly in the following detailed description, made in reference to enclosed drawings, given as non limitative examples, such that:

FIG. 1 shows the acceleration of an electron, in an atom, by an external constant electric field called E;

FIG. 2 is an example of device using several layers of superconductive materials, powered by electric pulses (the cryostat is not represented);

FIG. 3 is an example of a variant of the device using superconducting layers, powered by an alternating current (the cryostat is not represented);

FIG. 4 is an example of a variant of the device using superconductors, in its amplifier only version, powered by electric pulses (the cryostat is not represented);

FIG. 5 is an example of emitting and amplifying device using the acceleration of ions in a low pressure gas contained in an airtight and insulating enclosure, powered either continuously or by successive electric pulses (in this example, negative ions are accelerated);

FIG. 6 is an example of flat mosaic of emitting/propulsive devices, arranged in order to obtain a wider propulsive flux;

FIG. 7 is an example of curved concave mosaic of emitting/propulsive devices, arranged in order to obtain a concentrating effect of the emitted propulsive fluxes;

FIG. 8 is an example of convex curved mosaic of emitting/propulsive devices, arranged in order to obtain a dispersive effect of the emitted propulsive fluxes;

FIG. 9 is an example of a compact device module with three layers of superconductors; and

FIG. 10 is an example of a schematic drawing for an application as an electric generation module, the cryostat being not represented.

### DETAILED DESCRIPTION THE INVENTION

### General Principles of the Invention:

In order to understand the invention operation, it is necessary to refer to the existence of two natural forces: the inertia force and the gravity force.

The inertia force Fi appears when a mass of matter is accelerated. There exists effectively a resistant force that it is to be overthrown to move the mass of matter. The Newton Law allows us to know the force Fi which must be applied to communicate an acceleration A to a mass M: this force is expressed by the relation: Fi=M A.

The gravity force Fg appears when two masses of matter M and M′ are present, at a distance D. Newton has also shown the universal attraction law:

Fg=G M M′/D²

in which the gravitational constant G is, in fact, a mean to measure the flux of natural quanta, responsible for the acceleration of the two masses, that we call gravity, and their way to interact with matter.

We need first to understand that the inertia force and the gravity force are both the result of only one and same natural phenomenon : the existence of a non isotropic distribution of the Universons interacting with matter when this matter is accelerated, whatever the cause of the acceleration.

The theory postulates effectively that there exists a natural, isotropic, flux of quantum bearers of kinetic impulse, that are continuously captured and re-emitted by the elementary particles of matter. They exchange their impulse with matter. Therefore there would be an incident and an emergent flux of Universons for each elementary matter particle.

Precisely, the theory demonstrates that a flux of Universons, emerging from an accelerated particle of matter, in the direction of its acceleration A, and only inside the solid angle Ω:

Ω=2πAτ/c (1)

is always larger than in the opposite direction, where the Universons are never re-emitted. In the previous expression, τ is the capture duration of the natural Universons by matter, and c is the speed of light.

These parameters have apparently the following values:

τ=5.58.10 ⁻¹⁴ second.

c=3.10^{8 m/s}

Therefore we can observe that the emission solid angle Ω of the emerging anisotropic flux of Universons has always an extremely small value, whatever the matter acceleration value A.

The invention uses the symmetry of the theory, therefore, the exactly inverse, artificial phenomenon: the device creates an artificial anisotropy of the natural flux of Universons that propagates through it. An anisotropic flux Φ of Universons, very directional, is created artificially, flux able to exert a pushing acceleration on matter, whatever its nature, and able also to auto-propel the Universons emitting device, in the opposed direction of the propagation direction of the emitted anisotropic flux.

### Scientific Justification of the Invention:

The natural phenomena described here seems to have a behaviour which is close to the validity limit of classical physics, where the use of quantum physics would be justified. However, in order to simplify the presentation, classical physics will be used here.

Let us determine, as an example, the anisotropic flux Φ of Universons emitted by a beam of charged matter particles, accelerated by an electric field E.

Let us call:

Eu the proper energy of one Universon, expressed in Joules: Eu=8.5.10⁻²¹ J.

τ the capture time of one Universon by matter, in seconds: τ=5.58. 10⁻¹⁴ s.

It should be noted that the values of these two fundamental parameters have been established: for Eu, from the results of a unique experience, for τ, on the basis of known quantum waves phenomena. These values have still to be confirmed and measured more accurately by other experiments. Precisely, the invention has also for objective to allow direct experimentation in the laboratory, and to allow new experiments, made for checking the predictions of the Universons theory. This will give the possibility to measure directly the values of the fundamental parameters of the theory, that have been obtained previously from confirmations by astronomical and space sciences observations. Let us continue:

c the speed of light expressed in meters per second. c=3.10⁸ m/s

e the electric charge of the accelerated matter particle expressed in Coulombs. For an electron, e=−1.602. 10⁻¹⁹ C;

m the matter particle mass, in kilograms. For the electron: m=9.11.10⁻³¹ kg.

E the accelerating electric field, expressed in volts per meter.

Ap the matter particles acceleration (meters per square second).

Ω the solid angle where the Universons are re-emitted in a larger flux intensity, by each accelerated matter particle, in the acceleration direction (steradians).

n the number of Universons captured, or re-emitted, by a particle, during time τ.

N the number of Universons captured, or re-emitted, by a particle, during one full second

Fs the quasi uni directional flux re-emitted by a single accelerated particle of matter, inside the solid angle Ω (Universons per second).

Φ the quasi uni directional total flux re-emitted by all the accelerated particles of matter, inside the solid angle Ω (Universons per second).

And finally I is the current of accelerated charged particles (Amperes).

The Universons theory demonstrates that a flux of Universons, larger than the natural isotropic flux, is re-emitted, by any accelerated particle of matter, in the direction of the acceleration, and in the solid angle Ω:

Ω=2πApτ/c (2)

The Universons theory demonstrates also that, during time τ, each matter particle of proper mass m captures a number n of Universons given by:

n=m c²/Eu (3)

Therefore, the total number N of Universons re-emitted each second by a matter particle in the 4π steradians is given by:

N=n/τ=m c²/(Eu τ) (4)

Consequently, in the solid angle Ω the number Nu of Universons re-emitted each second by a single matter particle at rest is given by:

Nu=NΩ/4π=Ωm c²/(4πEuτ) (5)

However, we have demonstrated that, in the acceleration direction, the anisotropic flux of Universons Fs which is re-emitted by an accelerated particle of matter, is two times larger than the one which is normally re-emitted in the solid angle Ω when the matter particle is not accelerated. Therefore, for a single accelerated particle:

Fs=2 Nu=Ωm c²/(2πEuτ) (6)

So, taking into account expression (2):

Fs=Ap m c/Eu (7)

Besides, the acceleration Ap of the charged matter particle, caused by the applied electric field E, is known from the following classical expression:

Ap=E e/m (8)

Therefore the result is evidently:

Fs=E e c/Eu (9)

Let us recall that Fs is the anisotropic flux of Universons re-emitted by a single, charged matter particle, which is accelerated by an external electric field E.

We observe here that the proper mass m of the accelerated matter particles has no influence on the intensity of the anisotropic flux of Universons which is re-emitted, contrarily to a common intuition.

This fact has a great importance, because it is possible to choose, as charged matter particles to accelerate, inside the invented device, electrons as well as protons, and that we even have an interest to choose the acceleration of heavier charged particles (ions), because their individual electric charge e can be larger than the one of an electron.

Effectively, with the acceleration of doubly ionized ions, the charge e in expression (9) is doubled, and the flux Fs is also doubled.

Now, if we have not only a single charged accelerated matter particle, but a large number of accelerated charged particles each second, this means an electric current of intensity I amperes, the total anisotropic flux of Universons Φ caused by the current of accelerated matter particles will be associated with:

One ampere=1/e=6.24.10¹⁸ particles of charge e per second (10)

Therefore:

Φ=3.52.10²⁸ I E (11)

We do know three of the parameters of expression (11), so for a current I of electrons or protons, or of simply ionized ions, we get:

Φ=3.52.10²⁸ I E (12)

This means that the intensity of the anisotropic flux of Universons emitted by the invented device is proportional to the current I and also proportional to the electric field E, when only electrons or protons, or simply ionized ions, are accelerated by a constant electric field.

However, expression (12) contains several implicit hypotheses. Effectively, this expression is only valid if the particles are effectively submitted to a constant acceleration of the same direction (and only if the accelerated particles are not relativistic or have not an average constant speed).

### Auto Propulsion of the Emitting Device by the Emitted Universons Flux:

Our results say that matter captures and re-emits natural Universons permanently.

When matter is at rest or is moving at a constant speed, the captures and the re-emissions of the Universons are isotropic. Consequently, the quantum kinetic moments exchanged between each Universon and matter, in both directions, are equal and also isotropic. Their sum is macroscopically null on average.

However, when matter is accelerated, these kinetic moments are no more isotropic and their macroscopic average resultant is no more null. It appears that it is precisely this phenomenon that is responsible for the inertia force (and also responsible for gravity).

In the particular case of the propelling device of the invention, it is not the device itself which is accelerated by an external force, but it is only certain charged particles of the matter of this device, that are accelerated by an electromagnetic process. But the result of this acceleration is again an anisotropic flux Φ of Universons emitted by the full device, and these emitted Universons emerge from the device at the speed of light.

First of all, this Universons emission is accompanied by a kinetic impulse transfer from the accelerated matter particles to the re-emitted Universons. This impulse is not compensated by the impulse of the natural, isotropic Universons.

Consequently, the emitting device is pushed in the opposed direction of the anisotropic emitted flux.

Secondly, the emitted anisotropic flux Φ is extremely concentrated, because its space extension is limited to the solid angle Ω which is always extremely small. Therefore, this anisotropic flux can push irradiated matter at very large distance, whatever the material obstacles interposed along its trajectory.

In fact, any matter being along the anisotropic flux Φ trajectory is pushed.

In reality, it is the natural, isotropic flux of Universons, which is the primary energy source of this mechanical interaction between matter and an artificial anisotropic flux of Universons. The proper energy of the natural isotropic flux is gigantic, inexhaustible, and available everywhere in the Universe.

In galaxies, for example, which are the main structures of the Universe, it is thanks to this phenomenon that the orbital kinetic energy of the stars is much larger than the gravitational potential energy.

Let us take an example, based on the acceleration of electrons in expression (12):

If E=1 000 000 V/m, with a current I=10 000 amperes, the anisotropic flux of Universons re-emitted by this current would be:

Φ=3.52.10³⁸ Universons per second

This is a considerable flux.

Effectively, each Universon of the flux Φ has a proper impulse Eu/c which is transferred to the Universons by the emitting device. Therefore, it is a total impulse:

P=Φ Eu/c (13)

which is transferred by the device emitting the flux. Besides, if this device has a total mass M, it should be accelerated with an acceleration Am:

Am=Φ Eu/(M c)=0.997 I E/M (14)

As an example, let us consider again E=1 000 000 Volts/m, and I=10 000 Amperes, and M=1000 kg, the device acceleration would be one million g!

However, such an example is illusory, because the anisotropic Universons flux Φ is only emitted during the very brief time it is possible to accelerate the matter particles. As soon as the accelerated particles get a constant speed, or become relativistic, there is no more anisotropy of the re-emitted flux of Universons, and there is no more propulsion of the mass M in the previous example.

Consequently, an emitting device emitting Universons, by using the acceleration of particles, must better be used with very brief successive impulses. Evidently, variants of the device can use a variable acceleration of the matter particles during time, or the successive acceleration of different charged particles.

### Action of the Anisotropic Flux of Universons on Distant Matter:

In a similar way, each Universon of the emitted anisotropic flux Φ, interacting with any matter particle, transfers to this particle its impulse Eu/c=2.83.10⁻²⁹ kgm/s. This, provided that the Universon be captured by the matter particle. The product ΦEu/c of expression (14) is expressed in kgm/s², because the flux Φ is expressed in Universons per second. Therefore this product is a force.

The matter irradiated by the anisotropic flux of Universons is accelerated.

In the hypothesis where all the Universons of the anisotropic flux of Universons would be captured by the irradiated matter, this acceleration would be gigantic.

Effectively, if we pursue the previous example, with Φ=3.52.10³⁸ Universons per second, we observe that the force acting on any matter irradiated by this flux, would be equal to 10 billions Newtons. This is evidently an extravagant hypothesis.

However, if we adopt a more modest hypothesis, where matter would capture only one Universon of the flux, per million Universons crossing it, the force acting on any matter irradiated by this flux, would be nevertheless extremely strong, as it would be equal to a thousand Newtons.

This is however the order of magnitude of the force measured in the experimental results obtained up to now (55000 Newtons with a 23 grams device).

In fact, the proportion of Universons of the anisotropic flux that are captured is theoretically proportional to the mass of matter which is irradiated. This mass is not necessarily the total mass of the matter body, because the anisotropic flux propagates only inside the solid angle Ω which is quite small.

About the partial capture of a natural anisotropic flux of Universons, the theory defines a “Specific Capture Cross Section S” of the Universons by matter. We have evaluated S from the previous determination of the capture time τ, because the theory demonstrates that the known Universal Gravitational Constant G is given by:

G=Sc/(4πτ) (15)

However it is not demonstrated that the value of the Specific Capture Cross Section S, valid for gravity, is the same for a very intense and concentrated artificial flux of Universons, as this is the case here.

Nevertheless, the theory predicts that the number of captured Universons is proportional to the mass of matter. In such conditions, it is not a force that is acting on the matter irradiated by the anisotropic flux of Universons, it is a constant acceleration.

And this is exactly what reveals the experimental results.

The use of the invention device will allow us to measure the proportion of the Universons, of a very directive flux emitted, that are effectively captured, and are pushing the interposed matter.

Nevertheless, this fact has already been demonstrated experimentally.

### Experimental Evidence of the Invention Principle:

Diverse scientific experiments, that have been made in the frame of fundamental research, and in which elementary particles of matter were very strongly accelerated, have revealed, totally fortuitously, and without any theoretical previous prediction from the experimenters, the pushing acceleration, from a distance, of matter objects, fortuitously situated far away, along the axis of the particles acceleration. In fact this matter was irradiated by the anisotropic flux of Universons emitted by the accelerated particles.

For example, we can refer to the experiments made and published in 2005, by Martin Tajmar and his colleagues, in Austria, under the sponsoring of the European Space Agency (ESA) and the US Air Force.

We can also refer to the fortuitous experiments made and published by E. Podkletnov, at the Chemical Institute of Moscow in 2002.

Several natural facts have also been observed, that correspond to the observation of the same phenomenon of an acceleration of distant matter, irradiated in reality by a natural anisotropic flux of Universons. For example the observation of the signal delivered by an ultra sensitive gravimeter during the 1997 Solar eclipse, by Unnikrishnan and al. in China.

### Physical Effects Caused by an Anisotropic Flux of Universons:

Theoretical predictions reveal that the interaction of an anisotropic flux of Universons with different kinds of matter is the cause of the following phenomena:

Propagation of the anisotropic flux, without deviation, at the speed of light, this in vacuum as well as inside any kind of matter.

Crossing of matter, by the anisotropic flux, without any absorption or attenuation.

Acceleration of any matter irradiated by the anisotropic flux, in the direction of the flux propagation. The acceleration value is independent of the mass and nature of the irradiated matter.

Very small angular dispersion of the anisotropic flux during its propagation. This confers a considerable range to the interaction of the anisotropic flux with matter, over astronomical distances.

Auto propulsion of the emitter device of an artificial anisotropic flux of Universons, in the opposed direction of the propagation direction of the flux.

Acceleration of the free electrons inside a conductor, irradiated by the anisotropic flux. The electrons displacement is an electric current. The energy which is transferred to the accelerated free electrons is withheld from the natural, isotropic flux of Universons, which is carrying a huge amount of energy, and which is inexhaustible at human scale. The partial direct conversion in electric energy of the anisotropic flux energy is made theoretically without attenuation of the anisotropic flux intensity, which is able to accelerate the free electrons.

Distortion of the orbits of atomic electrons in any insulator material which is irradiated by an anisotropic flux of Universons. This corresponds to the creation of an electric field. This effect is susceptible to depolarize the membranes of organic cells that have a natural polarization, caused by different concentrations of ions in the electrolyte, on both sides of the cellular membrane. Inversely, this phenomenon seems able to polarize certain cell membranes.

Other effects have also been theoretically predicted, such as the interaction of the anisotropic flux of Universons with photons.

A part of these effects, predicted from Universons theory calculation, have effectively been observed fortuitously, during the past fifteen years, by diverse experimenters, from experiments having not any relation with the invention, or the Universons theory. The experimenters were unable to explain the observed facts. These experimenters have however published their results, and all have make sure that no experimental artefact was able to explain the fortuitously observed effects.

All these effects are manifestly susceptible to generate numerous applications, provided that their origin is determined, and provided, evidently, that we know how to create artificially, specifically, surely, and reproducibly, a propulsive flux called by the invention creator an “anisotropic flux of Universons”. The means for the artificial creation of such a propulsive flux are the objects of the invention.

The device auto propulsion force, or the distant pushing acceleration of matter can be used, according to their intensity, for a very large number of applications.

The present invention concerns also the ensemble of applications using any artificial device producing an anisotropic flux of Universons, issued from the natural flux which is the cause of natural gravity.

### Scientific Justification of the Direct Electric Energy Generation by the Invention:

We have previously shown that an anisotropic flux of Universons accelerates matter it irradiates. This effect is simply the inertia phenomenon that manifests in reality itself at the level of the elementary particles of matter.

Therefore, in a conductor material, irradiated by the anisotropic flux, if the said material is maintained immobile, its internal free electrons are accelerated. This displacement of the internal free electrons, in the propagation direction of the flux, is an electric current.

So, there exists a possibility of direct conversion of the mechanical energy, carried by the propulsive flux, into an electric energy. This has been confirmed experimentally.

If the irradiated material is a superconductor, the energy conversion is made with extremely small energy losses. This principle is illustrated by the schematic drawing of FIG. 10, where a superconductor S is crossed by a concentrated anisotropic flux of Universons Φ. The electronic current pushed by the flux is powering a user charge U, connected to the electrodes e+ and e−. This system is not distinct from the invention, as it is only a particular application, reversed, of the amplification function of the invention, described farther.

However, we do know, since a long time, that nothing is an obstacle to gravity, and the experimental results confirm this fact extremely clearly.

Therefore, in the previous energy conversion system, the intensity of the emerging anisotropic flux of Universons is strictly equal to the intensity of the entering flux.

The theory of this energy conversion method demonstrates that it is the natural flux of Universons, through its interaction with the accelerated electrons, that is the source of the mechanical energy transferred to the electrons. Consequently, the incident anisotropic flux of Universons is not absorbed, it is only slightly modified in the temporal distribution of its Universons. Therefore, the emerging anisotropic flux is very slightly less concentrated that the incident flux. And the energy of the natural, isotropic flux of Universons, is also very slightly modified in the process.

But the theory demonstrates that it is possible to use the same anisotropic flux of Universons to generate electric energy inside a succession of aligned converting systems, in order to increase the total electric energy produced. The theory demonstrates that the successive modification of the characteristics of the anisotropic flux of Universons is extremely small, and that this is, at least theoretically, a promising way to extract artificially energy from the natural isotropic flux of Universons, cause of natural gravity.

### Functioning Principle of the Invention:

The natural Universons travel in all directions of space, at the speed of light, and they interact feebly with matter, by being sometimes very briefly captured by an elementary particle of matter, and then re-emitted without losing energy.

Therefore, the object of the invention is to use the energy of this natural flux of Universons, by obtaining, artificially, a local anisotropy of this natural flux, in order to create a propulsion and to allow multiple innovative applications.

The creation of an artificial anisotropic flux of Universons necessitates the strong acceleration of elementary particles of matter, such as electrons, neutrons, protons, or also the acceleration of positive or negative ions, obtained from neutral atoms, by diverse ionization methods.

As examples, we are going to describe here three types of technical methods to create artificially an anisotropic flux of Universons, able to accelerate matter from a distance, and able to create an auto propulsive force of the device itself. We will describe some variants, and we will propose details for one of these types.

However it is evident that, from this invention, it is easy to imagine other analogous devices for specific applications.

### First Mode of Realization:

The first mode of realization uses the acceleration, by any imaginable electromagnetic process, of electrons, inside a particular superconductor material object.

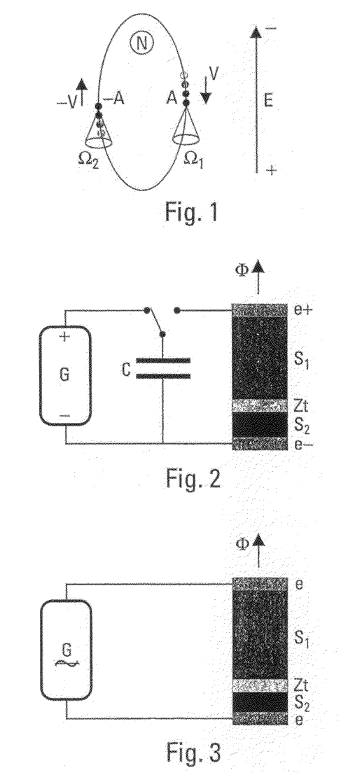

In order to understand the principle of this device, it is appropriate to examine the FIG. 1, representing the movement of a single electron around an atomic nucleus N, the atom being submitted to a constant external electric field E.

The electron is represented at two particular instants of its trajectory on the same FIG. 1.

In the constant electric field E, the electron is accelerated by the field. The field acceleration adds vectorialy to the acceleration caused by the nucleus N. The acceleration A is opposed to the direction of the electric field E for the negatively charged electron.

Due to the constant external electric field, we observe an important deformation of the electronic orbits, that become oblong, as on FIG. 1.

Therefore, when the electron is situated on the right side of FIG. 1, it is accelerated by the constant external electric field E, and this acceleration A is oriented in the reverse direction of the field, downwards on FIG. 1.

So, the accelerated electron re-emits a larger flux of Universons in the direction of its acceleration, in the solid angle Ω₁, where there is a larger re-emitted flux than in the other directions of space.

Half an orbit later, the electron is now in the ascending side, on the left of FIG. 1. Its speed is the same as in the previous position, but it is oriented differently, in the opposed direction, evidently. And as the electron is now moving in the direction of the external constant electric field E, it is decelerated. There is simply a acceleration—A acting now on the electron. This acceleration is oriented in the direction opposed to the electron speed, in the reference frame of the electron.

However, in the reference frame of the external observer, the acceleration—A that is acting on the left side electron has exactly the same orientation as the previous acceleration A of the right side position of the electron.

The electron, submitted to a constant external electric field E, is effectively always accelerated in the same direction by the electric field, whatever its position along its orbit. Consequently, the electron re-emits always a more intense anisotropic flux of Universons in the solid angle Ω₂.

It is clear, here, that the electron re-emits always an increased flux of Universons in the reverse direction of the external, supposed constant, electric field.

This same phenomenon repeats itself for all the electrons of all the atoms of the matter submitted to the electric field E. And this, with an intensity which is larger with a larger number of atoms submitted to the field, and larger with a larger number of electrons per atom, and larger when the bonding energy of the electrons to the nucleus is weaker.

However, a classical, electrically neutral material does not emit any anisotropic flux of Universons when it is placed in an external electric field. This because, in FIG. 1, we have omitted to represent what is happening to the protons of the atomic nucleus N. Effectively, the protons have the same charge as the electrons, but of the opposite sign. Therefore, the protons are also accelerated by the electric field E, but in the opposite direction of the electrons acceleration.

So, in a classical neutral piece of matter, the protons are also accelerated by the electric field, and they have a minuscule orbital movement, inside the nucleus, which is opposed to the one of the electrons. The accelerated protons re-emit also an anisotropic flux of Universons, in the opposed direction of the flux re-emitted by the electrons.

The two anisotropic fluxes, emitted by the charged particles, have exactly the same intensity, are emitted in opposed directions, and the macroscopic result is strictly null.

Nevertheless, we have theoretically shown the considerable intensity of the anisotropic flux of Universons that can be obtained from the only acceleration of electrons.

This is precisely this principle which is used in the device of FIG. 2.

FIG. 2 shows an example of a schematic drawing for the principle of one variant of the invention device, using a pulsed accelerating electric field, obtained by the periodic discharge of a capacitor.

The capacitor C is first charged by the DC generator G, when the switch (generally an electronic switch), is toggled to the left. Then, when the capacitor is charged, the switch is toggled to the right, and the capacitor discharges in the particular superconductor material S, made of two superconductive layers S₁ and S₂ separated by a transition layer Zt having a non null thickness. The whole material have previously been cooled down to a temperature which is lower than the critical temperature of the superconductive layer S₁, and superior to the critical temperature of layer S₂. The critical temperature of S₁ is higher than the critical temperature of S₂. The critical temperature of Zt is intermediary between the one of S₁ and the one of S₂. These properties can be obtained by slightly different chemical compositions of the materials of the three layers.

Therefore, at the functioning temperature of the device, layer S₁ is in the superconductive state, layer S₂ is only conductive. Layer Zt is “partially” superconductive (certain of its crystals are superconductive, others are not). On FIG. 2, the classical cooling cryostat for the superconductor material is not represented.

A very intense current of electrons flows through the device, from the top to the bottom of the FIG. 2, from the thin conductive electrode e− to the thin conductive electrode e+, and these electrons are submitted to a very strong acceleration somewhere along their path, because of an intense electric field. The electric current intensity varies during the discharge of the capacitor C.

The use of a superconductor material, having an adequate critical temperature is indispensable, in order to have an internal electric resistance almost null in S₁. Without this precaution, an electric field would exist inside the conductor material, and this electric field would accelerate the protons of the atoms, and the accelerated protons would emit an anisotropic flux of Universons that would subtract from the flux emitted by the acceleration of the electrons. The non superconductive layer S₂ emits two anisotropic fluxes of Universons, of the same intensity and of opposite directions. One of these fluxes is emitted by the acceleration of the electrons, and the other one by the acceleration of the protons. The Universons flux emitted by the electrons of S₂ is travelling in the direction Φ of FIG. 2. This means it is emitted in the direction of the layer S₁.

Inside a perfect superconductor, the electric resistance is strictly null, so the intense current of electrons travelling inside the layer S₁ does not create any voltage drop across this layer. Consequently, the electric field is strictly null inside layer S₁ of the device.

Therefore, the protons of the superconductor S₁ are not accelerated by the null electric field, so they do not emit any anisotropic flux of Universons.

Of course this same property can as well be applied to the electrons of the intense current, and in the absence of any electric field they should not emit any anisotropic flux of Universons caused by the acceleration of electrons in an electric field.

The phenomena that are existing inside the transition layer Zt are progressively intermediary between the one inside a conductor, and the one inside a superconductor. However, macroscopically, this layer has not a null electric resistance, the electric field is not null and some electrons and protons are accelerated inside this layer. An anisotropic flux of Universons is emitted by the accelerated electrons in the direction Φ of FIG. 2, this means in the direction of the superconductive layer S₁.

Therefore the superconductive layer S₁ is simultaneously crossed by an intense current of electrons, and by an anisotropic flux of Universons, created by the acceleration of the electrons inside the two other layers. A part of the flux is coming from the conductive layer S₂ and another part, probably more intense, is coming from the layer Zt. So, despite the fact that the electric field is null inside the superconductive layer S₁, the electrons of the intense current are however strongly accelerated inside this layer by the anisotropic flux of Universons propagating in the current direction.

It should be understood that an aleatory quantum statistical phenomenon is taking place inside layer Zt where certain crystals are superconductive and others are not. Therefore, the jumps of the electrons, between the crystals, correspond to a non null macroscopic acceleration in a common average direction, while the acceleration of the protons, oriented in almost all directions, give a macroscopic null effect.

Electrons having a proper mass, as all elementary particles of matter, they capture and re-emit Universons of the natural flux in an anisotropic way, when they are accelerated. Therefore, there exists an anisotropic flux Φ of Universons, very concentrated, and very intense, generally less dispersive than the light of a laser beam, in the acceleration direction of the electrons. This flux Φ is evidently pulsed at the rhythm of the successive discharges of the capacitor C.

The device of FIG. 2 is then auto propulsive. The propulsion force exists in the direction opposed to the propagation direction of the flux Φ.

Moreover, any mass of matter situated along the axis of the anisotropic flux Φ is accelerated in the direction of propagation of the flux. This acceleration of matter is analogous to the gravity acceleration, by its properties.

And this acceleration can be observed even at very large distance from the emitting device, because the angular dispersion of the emitted flux is quite small. This acceleration depends narrowly of the electrons acceleration, and this can be used in many variants of the emitting device, using the same principle.

The distant matter acceleration which is observed has been demonstrated experimentally. It has all the characteristics of the gravitational interaction acceleration. This means it has an infinite range, the acceleration is independent of the nature of the materials and of their mass, it is insensitive to any material obstacles placed along its direction of propagation.

Depending on the size, the shape, and the internal structure of the superconductive materials used to build a device of this type, and depending on the current intensity and the discharge duration, the anisotropic flux of Universons Φ which is emitted by the device is more or less intense and more or less concentrated. Therefore it is possible to modulate the emitted flux of Universons in intensity, in duration, and in orientation, in order to modulate the propulsive acceleration.

Before it is cooling down under the critical temperature, in certain types of these particular devices, the superconducting layer can be submitted to an intense magnetic field obtained with a solenoid or with magnets. This confers to the device, and to the emitted anisotropic flux of Universons, certain particular properties of intensity and of dispersion.

The device can be used for communications at very large distance (because it emits gravitational waves).

The device using a superconductor material can be miniaturized, in order to manipulate, from a distance, and without any contact, very small masses of matter, such as in intracorporeal exploration, in micro surgery, in molecular biology operations, and in nano-technologies, etc . . . .

But the device can also be made very large, by using a cold flat or curved wall, covered with many individual modules, in order to propel a vehicle for example.

It is also possible to use concentrating or dispersing devices, deviating the trajectory of the accelerated electrons, in order to concentrate, or to disperse, or to deviate the emitted anisotropic flux of Universons, which is responsible for the two kinds of propulsive effects demonstrated. This can be used to modify the needed push for an application.

### Example of a Variant of the First Mode of Realization, Where the Acceleration of the Electrons is Periodic:

The method of acceleration of the electrons, in the superconducting layers, must be chosen in a way that renders the speed of the electrons variable versus time, in order to get an emitted anisotropic flux of Universons. Therefore, an acceleration of the electrons obtained by a high frequency electromagnetic field, such as in the process of the schematic drawing of FIG. 3, is able to produce an electron acceleration which is proportional to the square of the field frequency, so a macroscopic push having this property.

In devices of this type, a powerful alternative current generator G is connected to the electrodes e of the complex superconductor material S₁+S₂+Zt which is cooled down under the critical temperature of layer S₁. The cryostat is not represented on FIG. 3.

The emitted anisotropic flux of Universons Φ is alternatively oriented in one direction and the other one, at the boundary of layer Zt, but the amplification phenomenon of the flux, by layer S₁ is active in only one direction. Consequently, the emitted flux exerts a propulsive force on the emitting device, and it can evidently accelerate matter at a large distance.

These types of devices are generally powered by induction, because of the very low impedance of the charge, the secondary winding of the induction transformer being the material of the device itself.

One interest of this kind of device is the possibility to obtain an anisotropic flux of Universons whose intensity is controlled by the frequency of the power generator, as well as by its output current.

In fact, if we imagine the electrons traversing alternatively the transition layer Zt of the device, we are conceptually returned to the FIG. 1 case, with a non symmetrical acceleration of the protons by the electric field.

All variants of the devices, accelerating electrons in a superconductor, of the said type or of a similar type, by their principle of operation, are part of the invention, as soon as their purpose is to create or to amplify a flux of energy accelerating matter and/or propelling the device itself.

An example of a particular superconductor material, which is susceptible to be used to build such a device, will be described further.

Let us continue to examine some variants of the invented device.

### Josephson Effect Variant:

In the device of FIG. 2, it is possible to replace the transition layer Zt by a very thin layer of insulating material. This layer is situated between two superconducting materials.

This kind of device looks like a Josephson junction. The electric field is concentrated inside the insulating layer. However, some electrons are able to jump through this barrier by tunnel effect, and they are strongly accelerated. The superconductive layer S₁ plays the flux amplifying role it had in the previous variants. This new variant is a part of the invention, because it is optimized to emit a maximal propulsive flux, which is not the normal use of such junctions.

### Cascade of Emitting and Amplifying Variant Devices of an Anisotropic Flux of Universons:

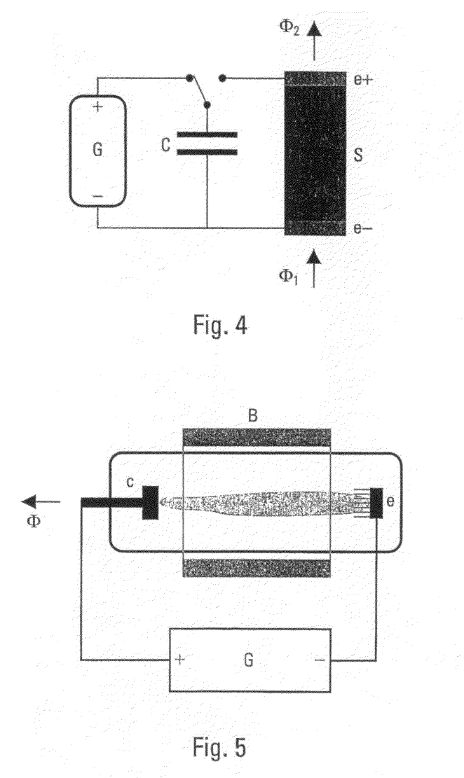

In the device described previously, for example the one using a fixed direction electric field, illustrated by FIG. 2, the superconductive layer S₁ plays the role of an amplifier for the anisotropic flux of Universons. Effectively, the free electrons that are travelling inside this layer are irradiated by the anisotropic flux puffs emanating from the transition layer Zt, and these Universons puffs accelerate the electrons by pushing them strongly in the direction of propagation of the flux. From this same principle, it is possible to make an amplifier only device, able to amplify the intensity of an incoming anisotropic flux of Universons, and based on the schematic drawing principle of FIG. 4.

This amplifier resembles the device of FIG. 2, except that the superconductor S has no particular layers. It is as perfect as possible and it is used at a temperature which is inferior to its critical temperature.

The classical cooling cryostat for the superconductor is not represented on FIG. 4.

In such an amplifier device, an input concentrated anisotropic flux of Universons Φ₁ is amplified, and the flux Φ₂ emitted at the output of the device has the same direction of propagation but a much larger intensity.

Evidently, the puffs of Φ₁ and the pulsed power supply of the device must be perfectly synchronized, taking into account the propagation delay for the flux, and the time of establishment of the amplifying current inside the perfect superconductor S.

It is possible to make a cascade of synchronous amplifiers, in order to obtain a final propulsive flux of the needed intensity by distributing the electrical power needed.

It is also possible to use the amplifier variant device with an emitter variant device using an alternative power supply, of the type illustrated by FIG. 3.

The emitter devices and the cascades of amplifier variants can also be mounted at the extremity of rotating arms in order to cover all the applications where a rotating movement is necessary.

Evidently, the amplifier device for amplifying an anisotropic flux of Universons, which is only a variant of the invention, is a part of this invention. It can be used alone, or inside a cascade, using other types of propulsive flux emitters.

### Electric Energy Generator Device Used at a Distance From a Propulsive Flux Emitter:

The anisotropic flux of Universons amplifier, illustrated by FIG. 4, is totally reversible. This means that, if this device is not powered by electricity, the input anisotropic flux pushes the free electrons and we get an electric generator. Evidently, in this mode of operation, the input flux is not amplified, so the output flux has the same intensity as the input flux. It is the natural, isotropic flux of Universons that communicates energy to the free electrons. This device is not different than the previously described amplifier. So it is a part of the invention as well.

Anyway, it is possible to use this variant device as a generator in a simplified way, according to the principle illustration of FIG. 10, where the capacitor and the switch have been suppressed. It should be noted that the electric generation application reverses the polarities of the voltage, as compared to the amplifier version. The cooling cryostat for the superconductor is not represented on FIG. 10.

### Detailed Description of One Variant of the Emitter Device:

High temperature superconductor materials were invented in 1986 by J. G. Berdnoz and K. A. Müller (Nobel price 1987), on the basis of LaBaCuO ceramics whose transition (or critical) temperature is lower than 100 Kelvin. Later, the use of Yttrium instead of Lanthanum was recommended. Other high temperature superconducting materials have then be discovered, and most of them can be used in the devices described here. It is with this kind of ceramic material that the invented device can be made, in its version using superconductors, as described previously. But, evidently, other materials are appropriate.

The description, which is made here, of the superconducting material that can be eventually used, in several variants of anisotropic flux of Universons emitters and amplifiers of the first type, illustrated as examples in FIGS. 2, 3 and 4, is made to understand the type of technology to be used in this variant of the invention device, and to understand also the particular precautions imposed by the invention.

The superconducting material to be used in the device of the first mode or realization is generally (but not always, for example when a flux amplifier is made), an intimate assembly, in layers, of a superconductor material, and of an ordinary conductor material, both being of the same crystal structure. Therefore at least two layers are used, separated by a transition zone.

In the actual status of the superconductor materials technique, there is an interest to use a high temperature superconductor material, in order to obtain a critical temperature, under an intense current, with a cryostat containing liquid nitrogen. However, functioning with a very high current density could impose the use of liquid helium, or at least its vapour. The classical cryostat is not described here, but evidently, it is essential, and its thermal isolation and/or regulation deserve a great care.

A scintered ceramic, made of Yttrium, Barium, Copper, and Oxygen, such as YBa₂Cu₃O_{7-y} (called Y₁₂₃ by most specialists) constitutes an example of superconducting material that can be used. The mixture can contain traces of Ce and Ag, conferring interesting properties for certain applications. This constitutes the superconducting layer.

The conducting material layer of the same structure, when it is needed, is generally composed of the same basic elements, to which are added traces of rare earths (Tr) according to the classical formula : Y₁₋ₓTrₓBa₂Cu₃O_{7-y}. The following rare earths can be used: Ce, Pr, Sm, Pm, Tb, etc.

The transition layer, which is necessary to make an emitter of an anisotropic flux of Universons, is often simply a progressive mixture of the two previous materials, or is automatically obtained during the thermal process.

The fabrication of this type of material uses for example the following public domain procedure, described only for information purposes, in strict conditions of temperature, of temperature increase and decrease speed, and purity of the base substances.

The process starts from finely milled powders (about one micron size), of Yttrium Oxide, Copper Oxide, and Barium Carbonate (Y₂O₃, CuO, and BaCO₃).

These substances must be very pure, their grinding and their ulterior manipulation must not bring any kind of pollutants, this point is very important.

Then the fabrication procedure is composed of the following operations: calcination, first annealing under an atmosphere of oxygen, grinding, pressing, and finally sintering and final oxygen annealing. These operations are eventually reiterated.

Therefore, during the first step, the preceding powders are finely milled an homogeneously mixed, in a volatile solvent, such as pure alcohol, during 2 or 3 hours, before evaporating the solvent.

Particular precautions must take into account the toxicity of Barium Carbonate for the personnel. Certain users use a dry mixing procedure, but the results are aleatory.

The calcination step of the powders mixture can be made in an air atmosphere inside a furnace during 20 to 24 hours at a temperature of 930-970° C. (It seems better to calcine at 950° C.). A mold made of alumina or porcelain is used to contain the powders during calcination.

In a variant of the calcination method, the mixed powder is placed in an induction furnace, for a thermal treatment at 830° C. during 8 hours, under an atmosphere of oxygen at low pressure (2 to 4 millibars). This is the protocol described by Balachandran (1989) and by Lindemer (1991).

In both variants of the calcination procedure, the matter is to obtain the basic structure of the material YBa₂Cu₃O_{6,5} and to eliminate the Carbon which is tied to Barium.

Then, during the next step, of annealing under an atmosphere of Oxygen, the porous an dense block of material, with a grey uniform colour, obtained after calcination, is first very finely milled, then placed in an alumina mold, and heated progressively to 500° C., temperature where starts the feeble flow of Oxygen in the furnace.

Then the temperature of the furnace is progressively increased until 925/975° C. is reached, where is remains constant for 18 hours with the same Oxygen flow.

A temperature of the furnace higher than 1050° C. can destroy the material.

The furnace cooling down must be very slow, not more than 100° C. per hour, until 400° C., where the Oxygen flow is stopped. Then the temperature decrease speed must not be more than 200° C. per hour.

Therefore, the total cooling down takes about 7.5 hours and the use of a well made furnace temperature regulator, conceived for such temperature ramps is preferable.

In a variant of the first annealing step, the porous an dense block of YBa₂Cu₃Oₓ material, with a grey uniform colour, obtained after calcination, is first very finely milled, then pressed into “pellets” under a low pressure press. Then the pellets are heated in a furnace having an air atmosphere, at 1050° C. , with a very slow temperature rise during 10 hours. The pellets are then cooled down very slowly to get to 1010° C. in 4 hours. Then the cooling down continues to 960° C. in 25 hours. Finally the ambient temperature is attained after 10 hours. This is the variant procedure called MTG, described by Murahami (1992) and by Narki (2000).

During the next step, the obtained pellets (or the more or less agglomerated powder) are milled in a ball mill or in a mortar with a pestle. By careful milling, and eventually by sifting, grains smaller than about 30 microns are only retained for the next step. It is particularly important to avoid introducing impurities in the powder during this operation, particularly traces of a magnetic material coming from the mill, the pestle, of the sieve.

If the powder obtained during this operation contains some green grains, a repeated annealing under an atmosphere of Oxygen is necessary, by the same process.

The same procedure is used, but separately, for the two types of materials needed for the two main layers of the device: the superconducting material YBa₂Cu₃O_{7.5} and the conducting material Y₁₋ₓTrₓBa₂Cu₃O_{7-y}. Both materials being consequently obtained in the form of fine powders.

The conductor material containing traces of rare earths is produced with different proportions of the chosen rare earth, to make the more favourable transition zone.

The next step of the procedure is the assembly and pressing of the different powders. The different layers are cold pressed simultaneously in a mold. Each powder is eventually mixed with a volatile binder (for example polyvinyl alcohol or even distillate water). First, the conductive material Y₁₋ₓTrₓBa₂Cu₃O_{7-y} powder is put into the mold, with a thickness of about 30% of the total future thickness of the final device. The conductive layer is then pressed moderately.

Over this conductive layer, is made the transition layer, composed eventually of several thin powders layers of Y₁₋ₓTrₓBa₂Cu₃O_{7-y} of decreasing proportion x of rare earth. This is what will make the transition layer.

And finally, over the previous layers is introduced the remaining (about 70% of the total thickness) powder for the superconducting layer, made of YBa₂Cu₃O_{7.5} material. The diameter of the mold and the thickness of the superconductor material will determine the pushing flux of Universons emitted by the device (its performances).

The layers are then firmly pressed in the mold (at least under 50 MPa pressure).

Then it is necessary to take carefully the pressed powder cake out of the mold, for a final sintering and annealing in the furnace under an atmosphere of Oxygen.

There is an interest (but this is not an obligation) to seed the superconductive material end of the pressed cake with crystals of Sm₁₂₃ obtained separately, and having a volume of about one cubic millimeter. They are spaced by about 15 mm, and they facilitate the beginning of crystallization of the powder, during the final cooking. These cubic seeds are obtained by the process of nucleation and slow growth described by Todt (1997) and by Chan-Joog-Kim (2000).

The pressed cake, with or without the Sm₁₂₃ seeds, is thermally treated by the OCMTG procedure (In order to get an oriented crystalline structure), under an atmosphere of 1% Oxygen. This thermal treatment triggers the crystals growth of the superconductor material, by isothermal fusion, at the temperature where the growth is isotropic. This very delicate procedure allows to obtain the required structure of the material, in about 7 hours instead of 65 hours, with a very slow cooling.

The crystalline growth must be carefully watched in order to avoid it to get to the transition layer, because this would be susceptible to destroy the emitting properties of the anisotropic flux of Universons by the device, by a chemical interaction between the superconductive layer and the conductive layer.

To avoid this risk, a much simpler sintering method can be used as a variant:

The pressed cake is heated between 950 and 1000° C. during 18 hours, the temperature of 1000° C. is preferable, if the furnace is very well temperature regulated. Over 1000° C. there is a risk to destroy the material (and to bond it to the alumina mold). But under 950° C., the ceramic may have disastrous cracks.

During all these treatments the very slow cooling down is made under a saturated atmosphere of Oxygen, particularly between 900° C. and 300° C. The cooling down speed must be regulated and must not be larger than 100° C. per hour, particularly between 750° C. and 400° C. Even a slower cooling down is preferable in this temperature range.

During all these thermal treatments, the temperature increase speed must not be larger than 300° C. per hour, and a speed of 150° C. per hour is preferable.

The Oxygen flow must not bring impurities. Keeping the furnace under a saturated Oxygen atmosphere is crucial. If the furnace is airtight, an Oxygen flow of a few milli liters per minute can be enough.

It is possible to repeat several times the operation of annealing under an atmosphere of Oxygen, this improves generally the superconducting properties of the ceramic.

It is possible to avoid the delicate thermal operation of oriented crystallization (OCMTG) for the superconducting layer, which is susceptible to create defects (cracks) by the mechanical constraints, imposed by the process, on large blocks of material (more than 100 mm diameter). This by choosing, after milling of the pellets, to press the powder for sintering of the ceramic, a mixture of larger grains: about 55% grains of 0,4 to 0,5 mm size, then about 30% grains of 0,1 mm size, and the remaining with grains of less than 20 microns size.

After mixture, drying, putting the layers in a mold as previously explained, the assembly is more strongly pressed, up to 120 MPa pressure, then the pressed cake is cooked at 930° C. during 12 hours, and the cooling down to ambient temperature is very slow. The material obtained by this simplified process has less emitting performances, but it has no cracks, a very important fact, because in presence of cracks in the ceramic, the emission of an anisotropic flux of Universons is generally impossible.

The ceramic is then cut to the final dimensions of the device with diamond tools, because the material is very hard. The cutting begins eventually by taking off the thin layer of Sm₁₂₃ of about 0,3 mm thickness on the external superconducting face.

The fabrication procedure is terminated by measuring the emission or amplification characteristics of the final ceramic rod obtained.

The realization of emitters and amplifiers devices of an anisotropic flux of Universons in assembled mosaics is obtained by cutting small rods from larger ceramics, and by pairing their characteristics as needed.

The final material is sensitive to humidity, therefore it must be preserved in a very dry environment.

### The Use of a Trapped Magnetic Field Inside the Material:

The exact scientific causes of superconductivity of such materials is still debated, but it is experimentally clear that without an adequate superconductivity in one layer, there is no emission of an anisotropic flux of Universons. Effectively, it is necessary that the circulation of a very intense current of accelerated electrons, in this layer, does not create a strong electric field in the material. Because the acceleration of the protons by this field, in the layer, would cancel the anisotropy of re-emission of the Universons.

It seems that the addition of a powerful permanent magnetic field, trapped inside the superconducting material during its cooling down, is able to increase the intensity of the emitted flux of Universons (probably by allowing a larger acceleration of the electrons). This magnetic field can be obtained with a small solenoid whose axis is the direction of the current flow. A permanent neodymium magnet is another solution.

### Electric Power Supply of the Superconducting Device Variant of the Invention:

In order to have the device, made of three layers of a superconductor material (for example the Y₁₂₃ material described previously), emitting an anisotropic flux of Universons, it is necessary to cool down the S₁ layer under its critical temperature, determined for an intense current (generally around 70 to 80 Kelvins). The cryostat contains generally liquid nitrogen, of liquid helium, and/or their vapours, in order to obtain the correct functioning temperature and its regulation under a large electric power. Low power devices are able to begin working correctly under 93 kelvins. The probable evolution of superconductors materials technique will allow the use of higher working temperatures.

When the correct temperature of the device is established, it is necessary to accelerate strongly the electrons inside the materials, perpendicularly to the output superconductive layer face of the device.

The circulation of the electrons, inside the device, can be obtained by means of metallic electrodes, welded to the extremities of the three layers Y₁₂₃ ceramic (for example with Indium), and by applying a voltage between these two welded electrodes.

If the applied voltage is DC, the superconducting layer extremity must be positive, and the device is preferably used by repetitive impulsions.

In this case, the repeated discharge of capacitors is generally used to power the device, such as in the example of FIG. 2. In this example, the device is auto-propulsive, the anisotropic flux of Universons pulses being emitted by the positive end of the ceramic, and the propelling force being in the reverse direction.

However it is also possible to accelerate electrons in the superconductor device by using an alternative voltage at a high frequency. This uses an high power AC generator having a very low output impedance, connected to the terminal electrodes. Or it is possible to use an induction transformer, a better solution, but not always simple to implement.

In this particular case of AC power supply, the acceleration of the electrons is alternative, with a maximum acceleration proportional to the square of the frequency of the electrons current. Therefore, the intensity of the anisotropic flux of Universons emitted by the device is also proportional to the square of the frequency of the electrons current. However, the flux is only amplified in one direction by the superconductive layer S₁, and can mainly accelerate matter at a distance only in this direction. The auto propulsive effect exists also as the flux intensity is dissymmetric.

It is the type of application considered that dictates the more appropriate solution to use for accelerating electrons inside the device, according to the requested propulsion performances.

The devices powered by an AC generator are conceived in order to take into account the limited electromagnetic field penetration depth into the superconducting material. This is the reason why such devices use advantageously the mosaic configuration of small rods cut from a common, three layers, ceramic.

While very specific, the power supplies of devices using superconducting materials uses classic circuits well known by electronic engineers. Therefore these power supplies will not be described here, as well as the electronic switches for the pulsed discharges (the switch illustrated in FIG. 2).

### Concentrating and Dispersive Mosaics of Devices, for High Flux Intensity:

The invented emitting/propelling devices, or the cascades with amplifying devices, can be miniaturized, associated in parallel, synchronized, and modulated in emission power. This for example to cover the back surface of a vehicle, and obtain a new adjustable propulsion system, with an average anisotropic flux of Universons of a large diameter, having low effects on the environment, and being not a risk for living creatures, because the push of distant matter per unit surface would be quite small.

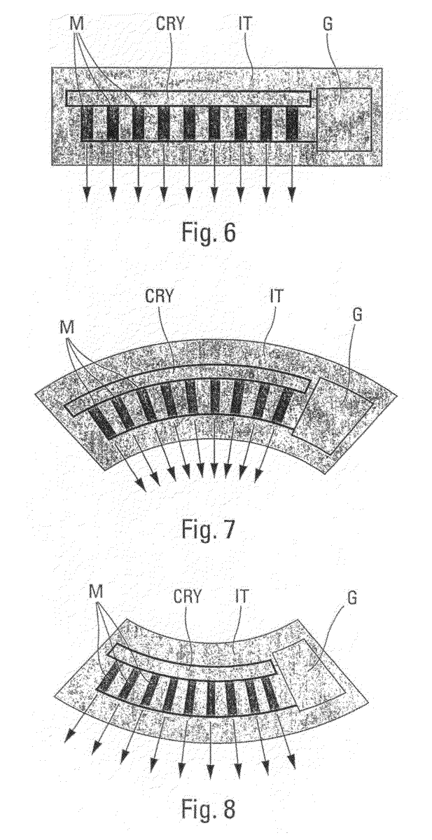

Let us take an example based on the previously described variant of emitting/amplifying devices using superconducting materials, but assembled into a mosaic, according to the schematic drawings of FIG. 6, or 7, or 8. Let us suppose that, in this example, a surface of one square meter is covered with many devices, using each the three layers of superconductor materials technique. Each individual device has an output surface of one square centimeter. The said figures show the devices Modules “M”, associated with a Cryostat “CRY”, and a power supply Generator “G”. The thermal insulation is “IT”.

The mosaics, illustrated as examples in theses FIG. 6, or 7, or 8, have all the advantage to be very compact and to be easily thermally isolated.

Therefore, the cooling of all the devices of the mosaics can be obtained with a minimal use of cryogenic liquid, particularly in applications where the device modules are not powered at high electric power level, a classical situation as we will show. So the use of such mosaics can be the best solution in many operational applications.

Emitting devices using superconductor materials, and having an individual section of one square centimeter, have demonstrated experimentally, that they can emit an anisotropic flux of Universons, of such an intensity, that the objects, placed along the flux axis, are accelerated at 5.10⁻³ m/s², and that, in little more powerful conditions, the experimental acceleration is 40 times larger. These are minima already acquired by this technology.

So, the distant push on matter, exerted by each module of the mosaic, is of the order of 0.05% of the earth gravity. Such an acceleration has no consequence on living creatures including humans, because it is equivalent to the change of gravity for an elevation of 1600 meters. This acceleration level is also without consequence for the environment. And an acceleration 40 times larger, being only 2% of normal gravity, is an effect without any more consequences.

However it is possible to assemble as much as ten thousand modules of this type per square meter of a mosaic. Therefore, the flux emitted by such a mosaic, if concentrated on a small piece of matter, would accelerate it at 50 m/s² which is five times the Earth gravity acceleration.

With devices of the mosaic used in more powerful conditions, the acceleration of matter, by the previous concentrating mosaic would be about 200 times the Earth gravity acceleration!

We understand that such a intense flux, concentrated on a very small zone, for example with a parabolic mosaic of the type illustrated by FIG. 7, would be able to allow very numerous new applications.

Taking into account the experimental results, such associations of the invented devices, in concentrating mosaics, with a lower surface than a square meter, are already able to be applied to the domains where it is needed to explore, or to manipulate material objects, of different kinds, without physical contact. For example, in non invasive surgery, even foetal, in odonto stomatology, for micro manipulations or industrial explorations of all types, in contaminating situations, in the domain of biology, for nano-technologies, for meticulous work in geophysics or archeology, etc . . . .

About the application of mosaics of the invented devices for the propulsion of vehicles, there is an interest to use a dispersive type of mosaic as shown on FIG. 8. This in order to reduce the value of the acceleration of matter irradiated by the propulsive flux. This kind of mosaic has no negative action on the level of the propulsion force, but the acceleration of matter, in the environment, is very small and decreases as the distance to the mosaic increases, because of the dispersive effect.

Devices of about one square centimeter section have demonstrated experimentally a propulsive force of several ten thousand Newtons when powered by short pulses. Therefore the total propulsion force of a large mosaic should be enormous. However, thanks to the low value of the natural specific cross section of the Universons/matter interaction, the effect on the environment is very low, as indicated previously in the example.

Using experimental extrapolations, for applications of terrestrial vehicles propulsion, it does not appear necessary to use the devices of the mosaics at a large power level, to obtain a sufficient propulsion force. And it does not appear necessary either to use very large surface mosaics. For example, to make a silent helicopter, without a rotor, and without an observable effect of the propulsive anisotropic flux of Universons on the environment, about a quarter square meter mosaic seems theoretically to suffice.

These examples reveal the possibilities of the mosaics of devices emitting an anisotropic flux of Universons.

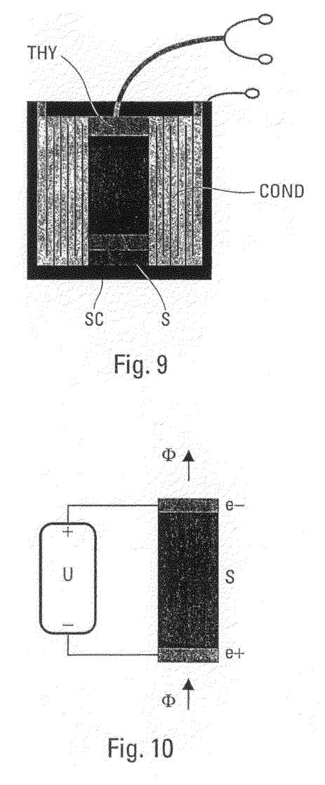

FIG. 9 shows the schematic drawing example of a compact emitting device variant using three layers of superconductor material. This kind of module can be easily used in mosaics. In this figure, the capacitor COND is coiled around the emitting device S, the switch is a thyristor THY, integrated into the module. A copper sole Sc is advantageously associated in this integrated device.

Another compact variant, not illustrated, would use a capacitor placed along the thyristor axis, and over it, in order to reduce to a minimum the section of the compact module, and increase the total flux emitted by the mosaic.

Let us continue exploring the example modes of realization.

### Second Mode of Realization:

A typical example of a second mode of realization of the invented device would use the acceleration of matter particles having a larger mass than the electrons, in order to emit an anisotropic flux of Universons. For example, it accelerates protons (ionized atoms of hydrogen), or even positive or negative ions, much more massive than the protons.

The principle of functioning of this second type of device is the same as the previous one. This means that the anisotropic flux of Universons is emitted by the charged particles strongly accelerated by an electromagnetic field. The charge of the accelerated particles being at least equal, or even larger than the one of electrons, and because the course of the particles in partial vacuum is longer than inside the grains of a superconducting ceramic, this kind of device (illustrated by FIG. 5) is able to emit a much more powerful anisotropic flux of Universons than the superconductor material type device, accelerating electrons.

In the example of FIG. 5, negative ions are accelerated by periodic discharges, inside a rarefied gas confined in an airtight and insulated enclosure.

A device accelerating positive ions can evidently be built on the same principle.

The DC generator G delivering a high voltage is powering periodically the discharge enclosure, where a partial vacuum is existing with an easily ionizable gas. There is a periodic avalanche of negative ions between the negative emitter of electrons e and the positive collector c.

Diverse classical means can be used to facilitate the ionization of the gas at the level of the emitter e, or to capture the electrons extracted from the atoms in the case of positive ions acceleration. Such as priming electrodes, a flux of particles emitted by a radioactive element, an electronic bombardment, etc . . . .

It is also possible to use the previous type of superconductor device as the cathode, placed inside or outside the gas enclosure, because it accelerates electrons and emits a strong anisotropic flux of Universons. The two types of pulsed devices would be synchronized.

The powered discharge enclosure constitutes an amplifier of the anisotropic flux of Universons that can be used with other types of emitting devices synchronized with its pulsed power.

In this kind of implementation, a three layers superconductor device, situated inside the enclosure, would constitute an efficient cathode, emitting electrons, and emitting also the flux to be amplified, so it would have to use the acceleration of negative ions in the enclosure.

In most cases, the enclosure must contain internal electrodes, or much better, one or several external solenoids (illustrated as B in FIG. 5), conceived to concentrate the discharge of accelerated ions in a narrow beam, as small as possible, and to render its trajectory reproducible from one discharge to the next. The anisotropic flux of Universons created by this type of device has the diameter of the ion beam, as demonstrated by the Universons theory.

By the same process as developed previously, the acceleration of the charged ions, by the high voltage, emits a concentrated anisotropic flux of Universons, in the acceleration direction of each accelerated ion. The flux is emitted in the direction of the enclosure collector of ions. As previously said, this flux is able to accelerate any irradiated matter, and to propel the entire emitting device itself. The device can be made small and be used in many copies inside a mosaic as previously explained, for the propulsion of vehicles.

This type of device, according to its size, its power, and the frequency of the pulses, can be adapted to all types of applications using a larger value of the acceleration than the superconductor type devices using the acceleration of electrons. The judicious choice of the gas to be ionized, and to create the intense discharge, allows to increase the intensity of the propulsive flux.

One advantage of this second mode of realization of the invented devices is that it does not need to use cryogenic cooling if a superconducting device is not used inside.

The discharge enclosure contains an easily ionizable gas with a large atomic mass, such as Argon, Mercury vapour, eventually Helium, at a pressure of about one Pascal. The pressure depends on the size of the ion beam, and also of the intensity of the current, and the voltage of the power supply. The order of magnitude of the free path of the accelerated ions must be equal to the distance separating the emitter from the collector of the device, such that the collisions of the ions, with the neutral atoms of the gas, do not impair the acceleration of the ions.

The discharge chamber is conceived in a way that if the acceleration of positive ions is used, the acceleration of created ions is not colinear with the acceleration of electrons in the reverse direction, as making a positive ion means extracting at least one electron that must go somewhere.

This is the reason why the collector and the emitter do not have the same geometry in systems accelerating positive and negative ions.

The ionization is facilitated by a geometry of the emitter creating a very concentrated and very intense local electric field. For example with sharp metal wires, as in the schematic drawing of FIG. 5. The enclosure can be surrounded by a cooled solenoid B where a large DC current creates a strong axial magnetic field, of the order of one Tesla, or more, in the axis of the ion beam. The objective of the magnetic field is to maintain the concentration of the beam, that must attain the collector always at the same place. Effectively, the ions having the same charge are repelling each other, and the ion beam would disperse in the absence of the magnetic field. It is extremely important that the ion beam remains very concentrated.

The emitter and the collector of the ionization chamber are made of materials able to sustain many discharges, very localized on their surface. A current of more than 10 kilo amperes during 10 to 100 microseconds, at each discharge is a typical example.

The functioning of this type of device necessitates a very high voltage power supply. So the collector emits a powerful beam of X rays that must be taken into account in the protection of the personnel.

It should be noted that such a type of device has been experimented fortuitously. It has created very briefly, but reproducibly, an acceleration of distant matter of more than ten thousand times the Earth gravity acceleration. The fortuitous experimenter has not understood and has not been able to explain the cause of the fortuitous observed acceleration of distant matter, because of the lack of an adequate theoretical background. But this was clearly one of the physical effects of a powerful anisotropic flux of Universons emitted by the accelerated beam of ions in this experiment, accelerating negative ions with several million volts, for scientific purposes, independent of the actual invention.

The Universons beam obtained at this occasion was unidirectional, in the axis of the ion collector, and its limits were abrupt, the beam being non dispersive. These are the clear signatures of an anisotropic flux of Universons, as predicted by the theory.

This type of emitting device can be used in a continuous regime instead of a pulsed one, provided it is correctly cooled. The use in pulsed mode is thermally much easier, as the voltage and the magnetic field are applied only briefly and regularly repeated.

It is possible to constitute a cascade of emitters and amplifiers with such variants of the invented device, provided they are correctly aligned and synchronized to increase the power of the output flux.

The entire device and its accessories should be enclosed in a thick enclosure absorbing the emitted X rays, the electromagnetic radiation, and the intense fields, as all these absorbing layers are totally transparent for the beam of Universons emitted.

### Other Variants of the Invented Device:

Other types of emitters of the propulsive flux, based on the same principle, can be made. They all have in common the fact that they accelerate strongly neutral or charged particles of matter of any proper mass.

One can use for example radioactive elements emitting alpha particles, accelerated by electromagnetic fields.

Diverse combinations of the diverse types or variants of the invented devices in the emitting or amplifying function of an anisotropic flux of Universons are all part of the invention.

The functioning by successive pulses is not a necessity, this is only an example. Analog systems functioning continuously of alternatively are part of the invention patent as well.

All these devices have in common to accelerate (or to decelerate) strongly particles of matter in the direction where it is needed to accelerate matter from a distance, or in the opposite direction of an auto propulsion force of the device. By reaction of the Universons on the accelerated particles, the invented device is generally propelled in the opposite direction of the emitted flux if this one is emitted in only one direction.

From this common principle, the invented device has many potential variants.

### Foreseen Applications of the Invented Devices:

This invention will induce many applications. It concerns effectively the realization and the use of diverse technical devices able to create, at a distance, without contact, and without deleterious effects, an artificial pushing acceleration of the irradiated matter, having the physical properties of the gravity acceleration. Any mass of matter situated along the, axis of the anisotropic flux of Universons Φ emitted by the invented device is accelerated by the flux, and this acceleration is analogous to the gravity acceleration.

This acceleration has a quasi infinite range because the angular dispersion of the emitted anisotropic flux is very small.

Moreover, the accelerating flux is totally insensitive to the material obstacles placed along its propagation axis, whatever these obstacles. And the acceleration endured by the body irradiated by the emitted anisotropic flux of Universons is independent of its proper mass, exactly as this is the case for gravity.

Furthermore, the anisotropic flux of Universons propels the emitting device itself, in a direction which is opposed to the propagation direction of the flux emitted.

Therefore, the technical and industrial applications of this invention concern a large number of domains: propulsion and transportation, mechanics, telecommunications, energy, including in the domains of space technology, medicine, surgery, pharmaceutics, biology, domestic, food processing industry, geophysics, even artistic, etc . . . .

These applications will grow in volume, with the improvement of the technology of the emitters of an anisotropic flux of Universons, and the development of new types of devices based on the same general principle.

They will begin probably by the applications satisfied by a low power emitted flux, to include, probably on the long term, those requiring a very powerful anisotropic flux of Universons.

It is already possible to consider effectively the few following examples of applications, not at all exhaustive, and without any consideration about the level of power needed, or their chronological emergence.

These applications examples are only presented by general domains.

### Applications in the Domain of Propulsion and Transportation:

Propulsion of vehicles of any nature: terrestrial, railroad, maritime, aerial (helicopters without rotor included), but also space vehicles, etc . . . . Effectively, in the version of the invented device emitting an anisotropic flux of Universons continuously or on a pulsed manner, the emitted flux propels the emitting device in the direction opposed to the direction of emission of the flux, so the vehicle containing the device is also propelled.

The invented device can create an adjustable “artificial gravity” where this appears necessary, for example inside a space vehicle, for the crew in weightlessness situation, in order to avoid the corresponding physiological consequences.

One of the very innovative characteristics of the vehicles propelled by these devices is to allow the use of considerable propulsion accelerations without discomfort for the crew. Effectively, the device is able to propel and also to accelerate matter at a distance. This distant acceleration acts at the level of all the elementary particles of matter, those of the vehicle as well as those of the crew. In this case, with an adapted configuration of the propulsive system, there could be no inertia effect and no limit of the vehicle acceleration acceptable for the human organism.

This means that, when this technology will be mature, it will be possible for such vehicles to adopt trajectories unrealizable with classical means of propulsion, such as abrupt stops, sharp turns, dazzling starts, etc.

The future long term performances concerning the high acceleration of the vehicles will be able to open new space perspectives, such as relativistic speed missions, this means interstellar exploration missions.

The cost of space launches will be considerably reduced, up to the point it will be possible to rentabilize the transportation of extraterrestrial materials. This will contribute to solve the problem of the limited natural resources of the Earth (fossil resources for example). The solar system planets are effectively rich of diverse resources.

The vehicles using a propulsion of this type will be able to simultaneously have the capabilities of many types of vehicles, such as helicopters, airplanes, space vehicles, boats, even submarines, if necessary. This kind of propulsion is able to operate in all conditions.

It will be possible to create, on the ground, on Earth, with the invented devices, a local condition of micro gravity, and to allow the corresponding applications on Earth, without the necessity to go to space for these applications.

### Applications in the Mechanical Domain:

The invented device will allow to lift any masses, without contact, just as with a crane or with an helicopter, but without any cable.

The invented device is able to push a mobile at very large distance from itself, such as a vehicle of any nature, without any propelling system on board the vehicle. The propelling flux, emitted by the invented device, is effectively insensitive to any type of obstacle, including the terrestrial globe, but it is adjustable in intensity and dispersion.

The invented device is able to rotate an axis (in order to obtain a rotating motor), for all applications already identified where a rotating system is required, but the invented device is exempt of any pollutant emission in the environment.

The invented device is able to produce mechanical energy in all its forms: for example to replace jacks, for digging deep wells, for moving large masses of landscaping machines, or agricultural machines, without the need to call for the adherence of wheels or of caterpillar tracks, on a very difficult and wet ground.

The invented device allows the micro-manipulation without contact in the techniques of electronics, biology, pharmaceuticals, and nano technologies. The fabrication of mixers, presses, and agitators, without any contact, are examples of important applications for numerous industries. They would not need a very high power emitted flux, so they will probably be developed rapidly.

### Applications in the Domain of Telecommunications:

With the invented device, it is possible to communicate information at very large distances, whatever the obstacles along the emitted flux path. The communication direction is extremely accurate, and cannot be received out of the emitted flux.

This kind of communications is very innovative.

### Applications in the Domain of Energy:

The invented device can rotate a classical electric generator.

The invented device can also produce directly electric energy, by pushing charged particles inside a conductor, or inside a superconductor. This fact constitutes a particularly promising application of this invention. The invented devices are completely reversible. This means that an anisotropic flux of Universons, acting on one of this devices, creates an intense electric current, by direct energy conversion, thanks to the displacement of the electrons, inside the device, by the acceleration induced by the flux. Inside a superconductor device, the energy would be produced without losses.

Therefore it appears theoretically possible to generate electric energy from these invented devices, the primary energy coming from the natural flux of Universons responsible for gravity.

The generation of electric energy can be obtained, for example, by a device schematized by the drawing of FIG. 10, where an input anisotropic flux of Universons Φ is sent through a superconducting material S, which creates an acceleration of the free electrons existing inside the material. The user charge U is connected to the electrodes e− and e+ of the device. This type of generator uses the symmetry property of the amplification phenomenon which is illustrated by FIG. 4.

However, in the electric generator of FIG. 10, the input anisotropic flux of Universons, and the output flux, have the same intensity. This fact allows to add other generators of the same type, in a cascade, using the same flux, in order to increase, as needed, the electric power generated, because the input flux is not absorbed by any material obstacle.

The primary source of energy of this system is the natural, isotropic flux of Universons, that acts on the accelerated electrons, inside the invented devices, to manifest the inertia of their own mass. One can understand the functioning of such a system by analogy with a waterfall, acting on a turbo generator, where the primary energy is the constant acceleration of the water molecules by gravity. And gravity is a constant anisotropic flux of Universons.

Inside the superconducting device, the electrons play the role of the water molecules of the waterfall, and their movement is an electric current. The cryostat, which is indispensable, is not represented on FIG. 10.

On the geopolitics point of view, this inexhaustible, and non polluting energy, will be favourable to the harmonization of the world, by allowing the co-development of the third world states. It will also contribute to re establish the energetic and ecological equilibrium of the Earth population, because this is an energy source without wastes and without pervert effects on the climate and on the ecosystem. It will be available everywhere.

### Preservation of the Environment:

The action, at a distance from the invented device, of an anisotropic flux of Universons, is silent and non polluting. This will allow to preserve the terrestrial environment, and to reduce considerably its degradation, caused mainly by the noisy and pollutant combustion of fossil resources, whose more judicious use and difficult substitution, in the chemical industry, will be able to be preserved. However, it is really through all industrial applications of the invention that the environment preservation will make progress.

### Applications in the Domain of Health:

The invention will induce many applications in the sectors of medicine, surgery, physiology, and biology.

These applications will probably be the first to be industrialized, because of their feasibility, as they will not need large and permanent accelerations, and also because of their impact, their implications in this very sensitive domain.

The appropriate use of the invented devices, notably in their version of concentrating mosaics, as illustrated by FIG. 7, will allow an accurate action at a distance on diverse tissues, through obstacles, a non aggressive action, without perverts or deleterious effects.

Therefore, the invention will allow new and non invasive intra corporeal treatments and investigations.

For example, it will allow micro surgery without opening and without contact.

As another example, it will allow to disencumber organic or vascular ducts, such as coronary or cerebral arteries, etc . . . . As well it will contribute to disencumber non vascular organic ducts, such as urinary, biliary, bronchial, etc . . . .

It will also contribute to destroy, from a distance, without contact, and without pervert effects, tumors, clots, stones, etc . . . .

Other possible applications of the invented devices, in the domain of health, will allow the introduction and guiding, from a distance and without contact, of intra corporeal devices, of a therapeutic nature, such as endo-protheses, or devices for the exploration and investigation of internal cavities. Again, the possible use of the invented devices to activate, from a distance, without contact, cardiac pumps or other kinds of equipment.

The applications of the invention, is this domain of health, concern the quasi integrality of the specialists in medicine and surgery. These applications are applicable for all the ages of the patients, including the ante natal and foetal domain. They are able to be developed in the therapeutic domain as well as in the investigative domain.

### Other, Totally Innovative, Applications:

The present invention will also allow new identified applications, tied to particular physical effects of an artificial anisotropic flux of Universons, experimentally demonstrated. For example, the modification, from a distance and without contact, of the electric properties of membranes, of electrolytes, etc. Through these effects, the invented devices will be able to intervene in physiological effects, physico-chemical effects, pharmacological properties. For example, induce an anesthesia without any use of chemicals. Or, other example, modifying the voltage of an electric battery from a distance. Such effects have effectively observed fortuitously and demonstrated experimentally.

While the present invention has been described previously in reference to certain modes of realization, and in reference to certain particular applications, it is understood that a user can introduce any modification or useful adaptation without being able to be considered acting out of the frame of the present invention, frame which is defined by the annexed claims.

1. Propelling device, by means of acceleration of particles, comprising means for accelerating particles of matter, mainly in only one direction, said means including an energy source and an enclosure containing the matter particles to be accelerated, said enclosure being powered from the said energy source, said accelerated matter particles remaining confined inside the said device.

2. The propelling device according to claim 1, wherein said matter particles are in particular electrons, protons, neutrons and/or ions.

3. The propelling device according to claim 1, wherein said enclosure includes at least a superconductor.

4. The propelling device according to claim 3, wherein said means further include a cooling cryostat, to cool down at least one superconductor at a temperature lower than its critical temperature.

5. The propelling device according to claim 3, wherein said enclosure includes a superconductor material made of several layers having slightly different chemical compositions and critical temperatures, in order to obtain, at the functioning temperature, one or several partly superconductive transition zones, one or several superconductive zones, and one or several conductive zones.

6. The propelling device Device, according to claim 5, wherein said enclosure includes first and second layers of superconductor material (S₁, S₂) separated by a transition zone (Zt), the critical temperature of the second layer (S₂) being lower to the critical temperature of the first layer (S₁), the critical temperature of the transition zone (Zt) being between the critical temperature of said first and second layers of superconductor material (S₁, S₂), such that, at the functioning temperature, the first layer (S₁) is superconducting, and the second layer (S₂) is not superconducting, the transition zone (Zt) being partly superconducting.

7. The propelling device according to claim 1, wherein said enclosure is not conductive and airtight, and contains a ionizable gas.

8. The propelling device according to claim 7, wherein said enclosure is powered by an electric voltage generator, providing discharges of ions that are accelerated in said enclosure, by appropriate electromagnetic fields.

9. The propelling device according to claim 1, wherein said energy source is continuous, alternative or pulsed.

10. Use of a device according to claim 1, to create, at a distance from the device, and without contact, a pushing acceleration of any matter, said acceleration having the properties of the gravitational acceleration, and being obtained artificially, by means of the acceleration of particles of matter remaining confined inside said device.

11. Use of a device according to claim 1, to create an auto propulsion acceleration of the device itself, said acceleration being obtained artificially, by means of the acceleration of particles of matter remaining confined inside said device.

12. Use of a device according to claim 1, to produce electric energy at a distance from the device, from a propulsive flux.
